(19) United States
(12) Patent Application Publication
(10) Pub. No.: US 2004/0168424 A1
(43) Pub. Date: Sep. 2, 2004

(54) Deck assembly for a self-propelled, walk-behind rotary lawn mower

(75) Inventors: James R. Baumann, St. Louis Park, MN (US); Chadwick A. Shaffer, Oakdale, MN (US); Chris A. Wadzinski, Inver Grove Heights, MN (US)

Correspondence Address: MUETING, RAASCH & GEBHARDT, P.A., P.O. BOX 581415, MINNEAPOLIS, MN, 55458, US

(73) Assignee: The Toro Company, Bloomington, MN

(21) Appl. No.: 10/798,616

(22) Filed: Mar. 11, 2004

Related U.S. Application Data
(62) Division of application No. 10/109,804, filed on Mar. 28, 2002, now abandoned.

(51) Int. Cl. A01D 69/00

(52) U.S. Cl. 56/320.1

(57) ABSTRACT

A deck assembly for a self-propelled, walk-behind rotary lawn rotary mower is provided. The deck assembly is configurable for either front or rear wheel drive and includes a deck defining a cutting chamber which may house a cutting member. The cutting chamber is bound at least in part by a rear enclosure member. The deck assembly also includes a side discharge port having a side discharge port door. A rear discharge port located on a rear portion of the deck is also provided. Preferably, a duct of substantially rectangular cross section extends through the rear enclosure member between the cutting chamber and the rear discharge port. In one embodiment, the duct has a first, uppermost surface and a second, lowermost surface, wherein the first, uppermost surface and the second, lowermost surface both form substantially horizontal planes.

### TECHNICAL FIELD

The present invention relates to walk-behind rotary lawn mowers. More particularly, the present invention relates to deck assemblies for use with self-propelled, walk-behind rotary lawn mowers.

### BACKGROUND OF THE INVENTION

Conventional walk-behind, rotary lawn mowers typically include a mower deck or housing supported by multiple, e.g., four, wheels. The top side of the deck forms an engine mounting surface to receive a prime mover (e.g., an internal combustion engine or an electric motor) while the underside of the deck forms a cutting chamber operable to house a cutting element, e.g., a cutting blade. The cutting blade is typically attached to a lower end of a vertical drive shaft, e.g., the engine crankshaft, which extends downwardly through the mower deck and into the cutting chamber. During operation, the crankshaft rotates the cutting blade at a speed sufficient to sever grass and other vegetation passing beneath the mower.

While some decks are designed solely for mulching, the deck is more typically designed to incorporate one or more discharge ports for ejecting grass particles or clippings. The particles of cut grass are discharged through these discharge ports by the operation of the cutting element, i.e., the air flow pattern induced by rotation of the cutting element is effective to propel the grass particles outwardly through the discharge ports.

For example, many lawn mowers have a side discharge port typically located on the right side of the mower deck (right side taken from the perspective of one who is standing at the rear of the mower facing forward). Such a discharge port is usually operable to propel grass clippings out a number of feet to the operator's right-hand side during a grass mowing operation.

In addition to discharging the grass clippings to the lawn, many rotary lawn mowers are also capable of capturing, e.g., bagging, the cut grass clippings. For instance, some lawn mowers use a flexible bag placed around a portion of the side discharge port. Other mowers, however, permit attaching the bag at the rear of the machine. The latter configuration enables a more compact design as the collection bag does not extend outwardly from one side of the mower, but rather protrudes directly behind it. As a result, the mower may be used in more tightly confined spaces and, furthermore, may mow grass closer to objects encountered along the right side of the deck.

To assist with operation, many walk-behind mowers may also be self-propelled, i.e., the front wheels or rear wheels may be driven by a transmission having a belt-driven sheave which is operatively coupled to a driving sheave on the engine crankshaft. Front wheel drive mowers are perceived by some users to have certain advantages such as simplified turning (e.g., the operator need only apply a downward force to the mower handle to elevate the drive wheels). Rear wheel drive configurations, on the other hand, may provide improved traction under some bagging conditions (e.g., better traction when the rear bag is full or near full).

Rear wheel drive mowers are typically configured with the transmission and driving sheave located at an elevation such that the drive belt is preferably routed above the deck and over the cutting chamber. While adequate for rear wheel drive configurations, this elevation is usually unacceptably high for front wheel drive mowers. As a result, different deck configurations are usually provided for different drive wheel configurations.

While self propelled, rear bagging mowers provide distinct advantages, drawbacks remain. For example, the rear discharge opening must generally be at an elevation sufficient to permit the passage of clippings over various mower components, e.g., over the rear wheel drive transmission and/or axle. Moreover, the elevation of the rear discharge opening should permit adequate distribution of the clippings to the collection bag. As a result, rear bagging mowers often utilize a mower deck having a portion sloping upwardly and rearwardly (sometimes referred to as a “scrolled deck”) in order to transport the grass clippings to an adequate elevation before discharging the clippings through the rear discharge opening.

While effective, the manufacturing and material costs associated with these highly sloped decks are generally greater than those having more uniform, e.g., flatter, deck shapes. Moreover, these sloped decks often require mulch plugs (devices used to plug the rear discharge opening during mulching operation) having complex shapes.

### SUMMARY OF THE INVENTION

The present invention provides a self-propelled, walk-behind rotary lawn mower having a deck that is configurable for both front and rear wheel drive. Moreover, decks in accordance with the present invention may utilize the same driving sheave and belt, and substantially the same transmission, regardless of whether the deck is configured for front or rear wheel drive. Decks of the present invention are also relatively flat, resulting in a comparatively low rear discharge port elevation. In some embodiments, a rectangular discharge duct extends from a cutting chamber of the deck to the rear discharge port. The duct may be substantially horizontal, e.g., the duct may be defined in part by both upper and lower substantially horizontal, planar surfaces. The horizontal, rectangular discharge duct may also permit the use of a simple rectangular mulch plug.

In one embodiment, a deck assembly for a self-propelled, walk-behind rotary lawn mower is provided. The deck assembly includes a deck defining a cutting chamber for housing a cutting member. The deck has a top wall portion spanning above the cutting chamber between a front portion of the deck and a rear portion of the deck. The deck is operable to receive either a rear wheel drive transmission proximate the rear portion of the deck or a front wheel drive transmission proximate the front portion of the deck.

In another embodiment, a deck assembly for a walk-behind rotary lawn mower is provided wherein the deck assembly includes a deck defining a cutting chamber. The cutting chamber is operable to house a cutting member and is bound at least in part by a rear enclosure member. The deck assembly further includes a rear discharge port located, when the mower is in an operating configuration, on a rear portion of the deck. A duct of substantially rectangular cross section extends through the rear enclosure member between the cutting chamber and the rear discharge port. The duct has a first, uppermost surface and a second, lowermost surface, wherein the first, uppermost surface and the second, lowermost surface both form substantially horizontal planes.

In yet another embodiment, a deck assembly for a walk-behind rotary lawn mower is provided wherein the deck assembly includes a deck defining a cutting chamber. The cutting chamber is operable to house a cutting member and is bound at least in part by a rear enclosure member. The deck assembly further includes a rectangular rear discharge port located, when the mower is in an operating configuration, on a rear portion of the deck. A duct of substantially rectangular cross section extends through the rear enclosure member between the cutting chamber and the rectangular rear discharge port. The duct defines a duct axis that is substantially parallel to a longitudinal axis of the mower.

In still yet another embodiment of the invention, a walk-behind rotary lawn mower is provided the lawn mower includes a deck assembly having a deck defining a cutting chamber operable to house a cutting member. The cutting chamber is bound at least in part by a rear enclosure member. The deck assembly also includes a side discharge port located, when the mower is in an operating configuration, generally along a lateral side portion of the deck. The side discharge port has a door associated therewith that is operable to selectively cover the side discharge port. The deck assembly also includes a substantially rectangular rear discharge port located, when the mower is in the operating configuration, on a rear portion of the deck. A duct of generally rectangular cross section extends between the cutting chamber and the rear discharge port. The duct is defined in part by a lower surface and an upper surface, wherein both the lower surface and the upper surface form substantially horizontal planes. The mower also includes: a plurality of wheels operable to support at least the deck assembly in rolling engagement with a ground surface; and a prime mover coupled to the deck assembly. A cutting blade located within the cutting chamber is also provided wherein the cutting blade is rotatable under control of the prime mover.

The above summary of the invention is not intended to describe each embodiment or every implementation of the present invention. Rather, a more complete understanding of the invention will become apparent and appreciated by reference to the following detailed description and claims in view of the accompanying drawing.

### BRIEF DESCRIPTION OF THE VIEWS OF THE DRAWING

The present invention will be further described with reference to the drawing, wherein:

FIG. 1 is a perspective view of a walk-behind rotary lawn mower having a deck assembly in accordance with one embodiment of the present invention;

FIG. 2 is a bottom plan view of the mower of FIG. 1;

FIG. 3 is a side elevation view of the mower of FIG. 1;

FIG. 4A is an enlarged perspective view of a portion of the mower of FIG. 1 illustrating a side discharge port door and a side discharge chute deflector;

FIG. 4B is a diagrammatic section view taken along line 44 of FIG. 2 with the side discharge port door closed and latched;

FIG. 4C is a diagrammatic section view taken along line 4-4 of FIG. 2, but with the side discharge port door open and the side discharge deflector installed;

FIG. 5 is a rear perspective view of a portion of the mower of FIG. 1;

FIG. 6 is a section view taken along lines 6-6 of FIG. 2;

FIG. 7 is a rear elevation view of the mower of FIG. 1;

FIG. 8 is a bottom perspective view of a portion of the mower of FIG. 1; and

FIG. 9 is a section view taken along lines 9-9 of FIG. 7 with the collection bag additionally shown.

### DETAILED DESCRIPTION OF EXEMPLARY EMBODIMENTS

In the following detailed description of the embodiments, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

Certain details of the mower may be excluded from the following description and, more particularly, from the accompanying figures, especially where the details are either unnecessary to an understanding of the invention or are otherwise generally known to those of skill in the art.

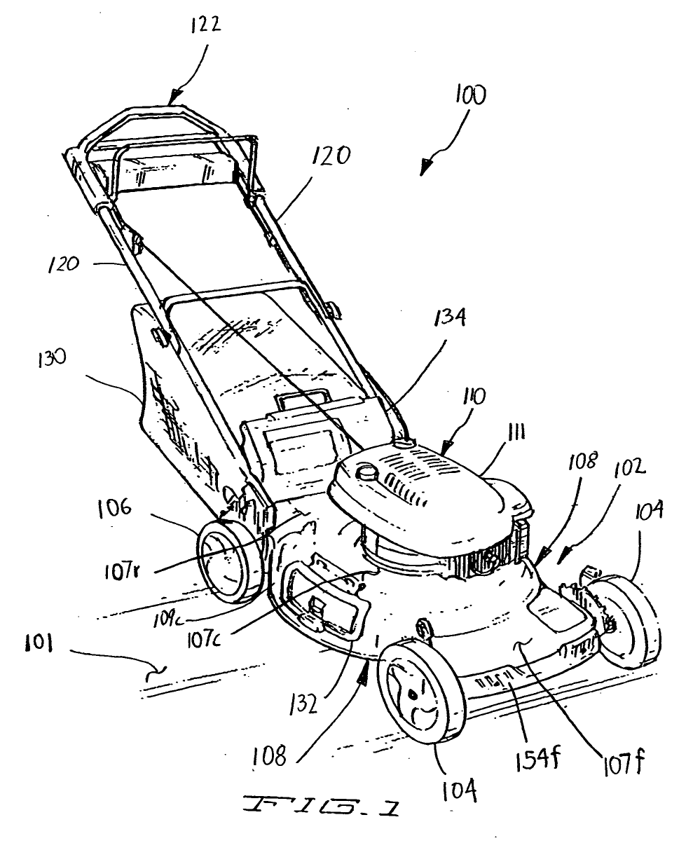

FIG. 1 illustrates a walk-behind rotary lawn mower 100 in accordance with an exemplary embodiment of the present invention. Preferably, the mower 100 is self-propelled in that one or more wheels are powered as further explained below.

The mower 100 preferably includes a housing or deck assembly 102 supported in rolling engagement with a ground or lawn surface 101 by a plurality of ground engaging wheels, e.g., front wheels 104 and rear wheels 106 (only one rear wheel visible in FIG. 1) positioned, respectively, at front and rear ends of the mower 100. The deck assembly 102 may include at least a deck 108 and various cutting chamber enclosure members as further described below. The deck 108 preferably forms an upper surface to which is mounted a prime mover, e.g., an internal combustion engine 111. While illustrated herein as an internal combustion engine 111, alternative power systems, such as an electrically powered motor, are also contemplated.

As used herein, relative terms such as “left,” “right,” “fore,” “front,” “forward,” “aft,” “rear,” “rearward,” “top,” “bottom,” “upper,” “lower,” “horizontal,” “vertical,” and the like are from the perspective of one operating the mower 100 (e.g., operator standing at the rear end of the mower and facing forward) while the mower 100 is in an operating configuration, e.g., while the mower 100 is positioned such that the wheels 104, 106 rest upon the generally horizontal ground surface 101 as shown in FIG. 1. However, these terms are used herein to simplify the description and not to limit the scope of the invention in any way.

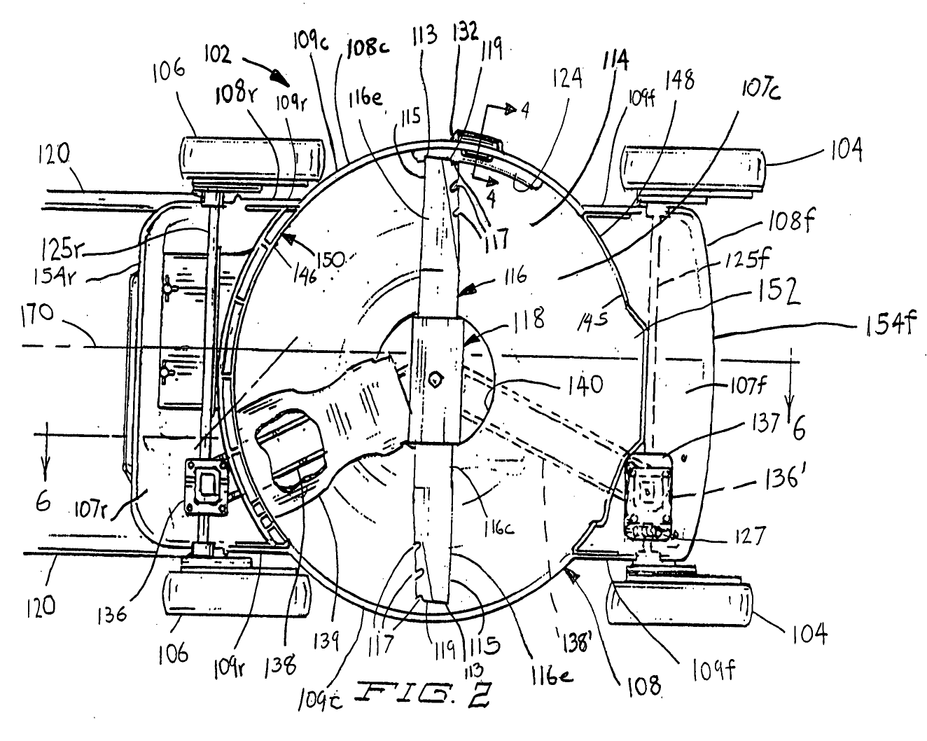

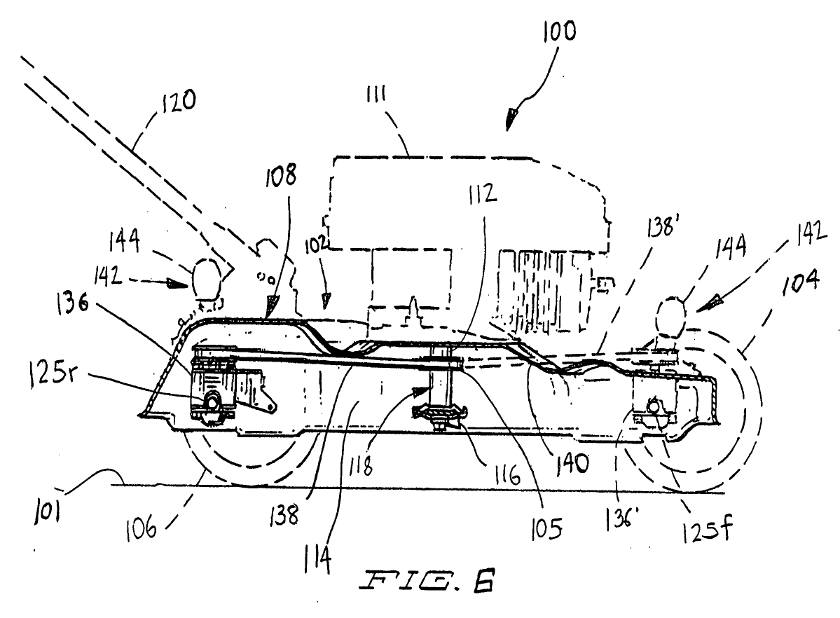

The engine 111 is preferably oriented such that its crankshaft 112 (see FIG. 6) extends vertically downward into a generally cylindrically shaped cutting chamber 114 defined at least in part by the deck 108 as shown in FIG. 2. A cutting member, e.g., a cutting blade 116, may attach to an end of the crankshaft 112 by way of a blade coupler assembly 118, an exemplary embodiment of which is described in more detail in copending U.S. patent application Ser. No. ______ (Attorney docket 206.00290101), entitled “BLADE COUPLER ASSEMBLY FOR USE WITH A SELF-PROPELLED, WALK-BEHIND ROTARY LAWN MOWER, filed on even date herewith. During operation, the crankshaft 112 rotates the blade coupler assembly 118, and thus the cutting blade 116, at a speed sufficient (e.g., at about 2400 to 3000 revolutions per minute) to sever grass and other vegetation over which the mower 100 passes.

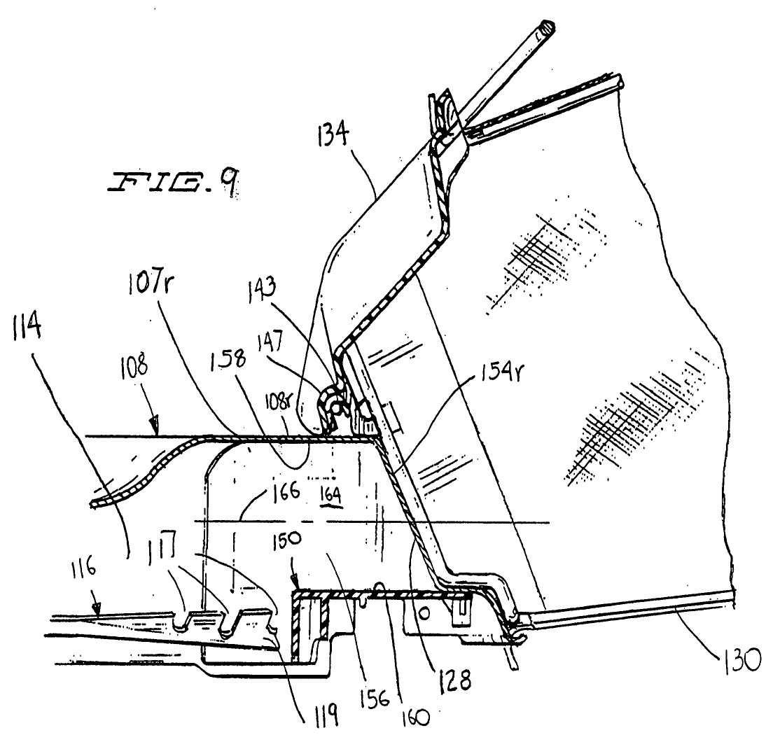

The cutting blade 116 is preferably an elongate member that is driven, with reference to FIG. 2, in a counterclockwise direction. The cutting blade 116 has a central portion 116c and end portions 116e, wherein end portions 116e have a cutting edge 115 extending from a tip 113 toward the center portion 116c along the respective leading edge of end portions 116e. A sail 119 may be provided at a trailing edge of each end portion 116e. The sails 119 slope upwardly with respect to the blade 116 as illustrated more clearly in FIG. 9. In the embodiment of FIG. 2, the sail 119 may include a plurality of notches 117. The notches may improve the ability of the blade 116 to more effectively mulch grass/vegetation.

In some embodiments, the mower 100 may use a cutting blade 116 similar to that described in U.S. Pat. No. 5,615,542 to Thorud et al. in that the upper side (not shown) of at least part of the center portion 116c of the cutting blade 116 may form one or more nonplanar surfaces, e.g., may form a generally concave upper surface. This blade profile, as described in the '542 patent, may provide improved mulching characteristics.

FIG. 1 also illustrates one or more handle members 120 which may extend from the deck assembly 102 generally rearwardly and upwardly to form an operator handle assembly 122. During operation, an operator walking behind the mower 100 may grasp the handle assembly 122 and control mower operation via manipulation of the handle assembly 122 and/or various controls located thereon. In some embodiments, the handle assembly 122 may be configured as generally described in U.S. Pat. No. D424,578 to Friberg et al.

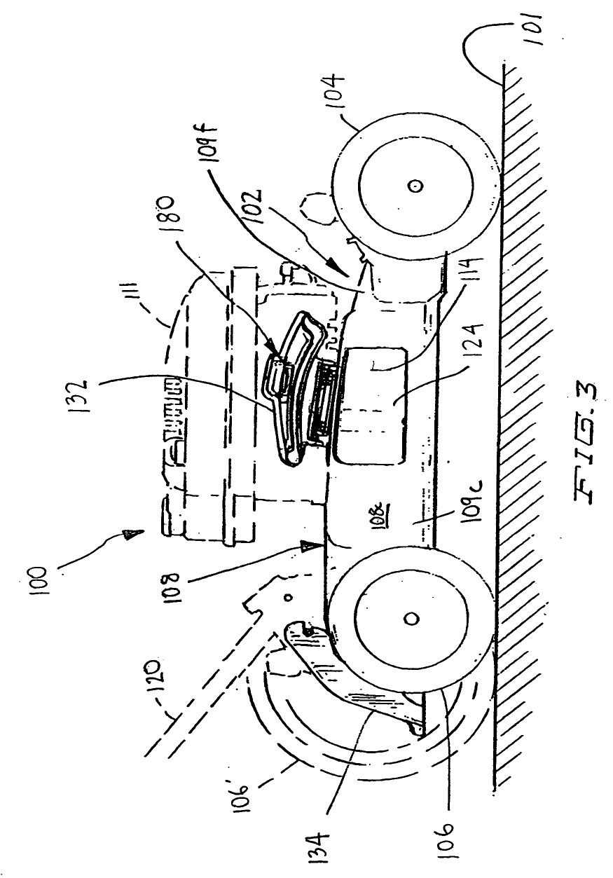

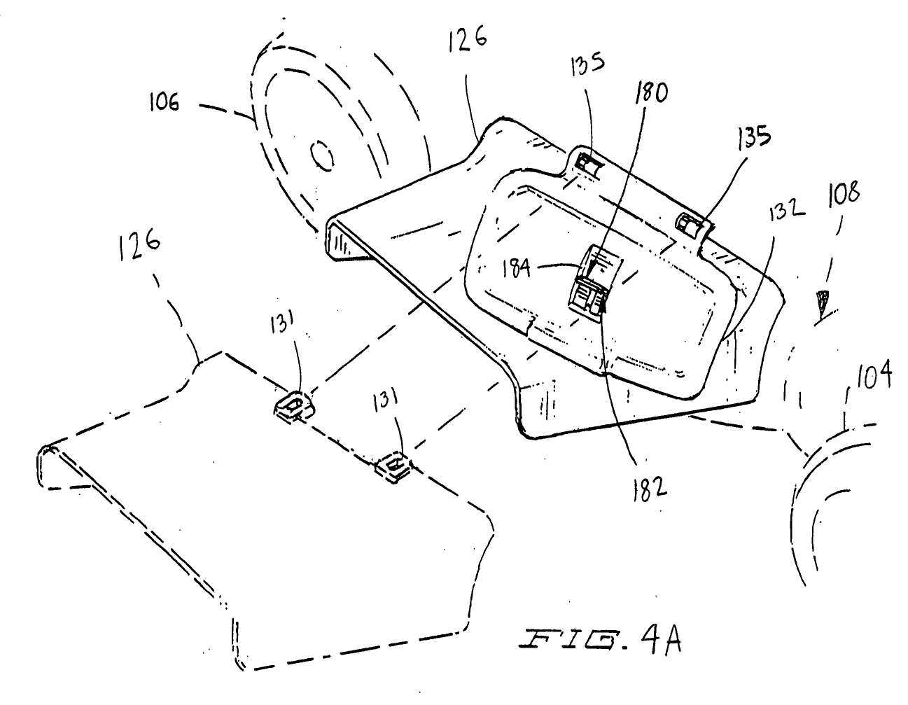

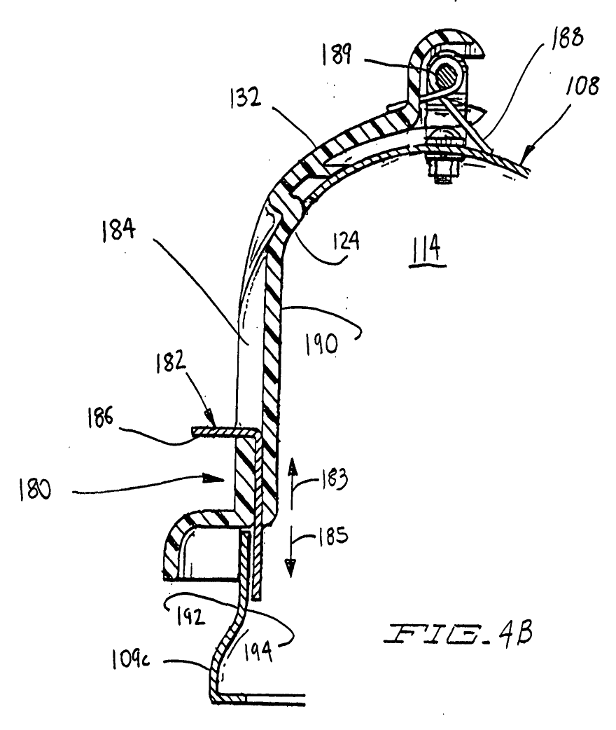

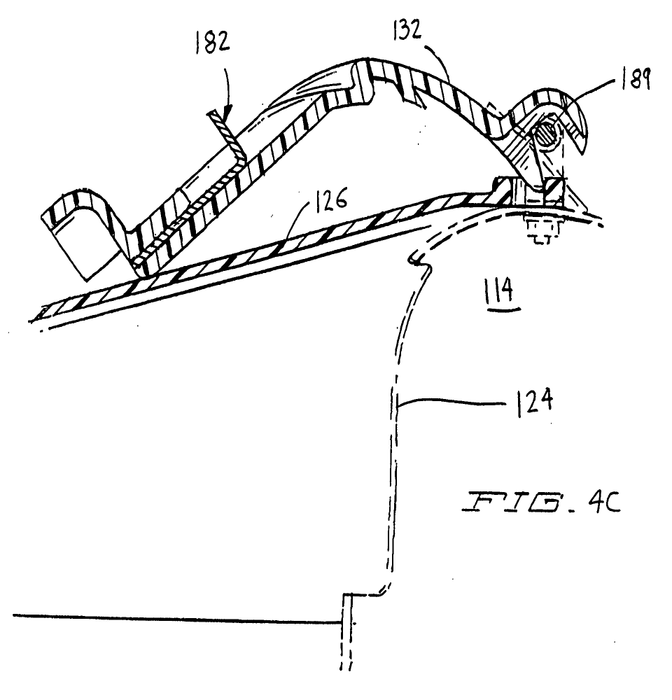

Preferably, the mower 100 may be configured to operate in any one of at least three modes. In a first mode, referred to hereinafter as “side discharge mode,” the mower 100 is configured such that grass clippings are discharged through a selectively openable side discharge port 124 located along a lateral side of the deck 108 as is clearly visible in FIG. 3. That is, grass clippings are propelled through the side discharge port 124 where they may then be distributed back to the lawn surface 101. To facilitate directional control of the grass clippings, a side discharge deflector 126, an exemplary embodiment of which is illustrated in FIG. 4A, may be coupled to the port 124 as further described below.

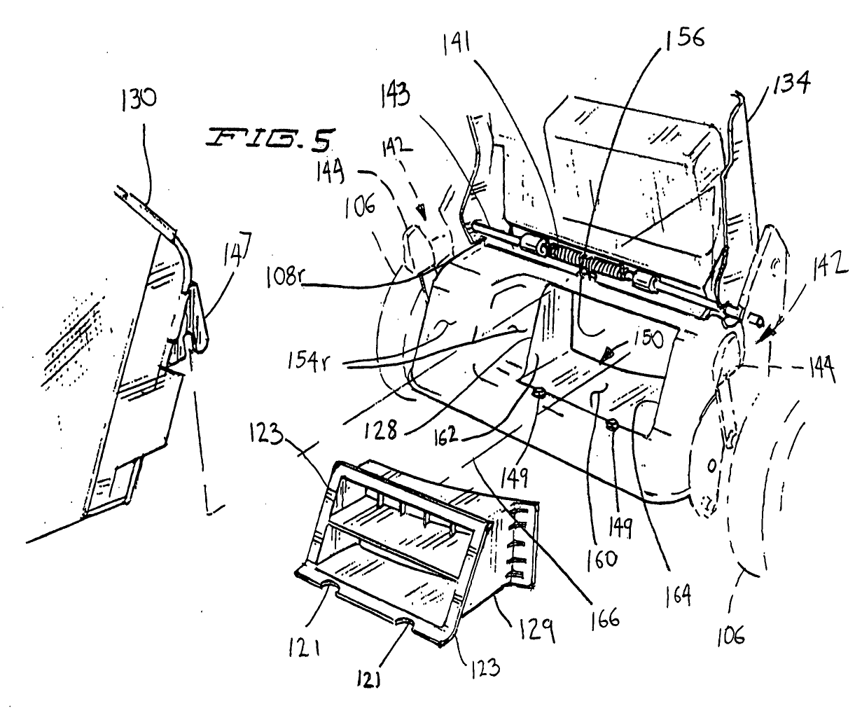

The mower 100 may also be configured as shown in FIG. 1 for what is referred to hereinafter as “bagging mode.” In bagging mode, the side discharge port 124 is closed and the grass clippings are discharged through a rear discharge port 128 which is perhaps best illustrated in FIG. 5. The clippings are received into a collection apparatus or bag 130 mounted to the rear of the mower 100 as clearly shown in FIG. 1. The bag 130 may be constructed of a wire frame supporting a flexible cloth outer layer. The bag 130 has an opening which may be placed in fluid communication with the rear discharge port 128 (illustrated in FIG. 9). Once full, the bag 130 may be removed from the mower 100, emptied, and reattached for further use.

FIG. 5 also illustrates a mulch plug 129 which may be used in place of the bag 130 when the mower 100 is operated in a third mode referred to hereinafter as “mulching mode.” In mulching mode, both the rear discharge port 128 and the side discharge port 124 (see FIG. 3) are closed (the side discharge port 124 is shown closed in FIG. 1 while the rear discharge port 128 is shown closed in FIG. 3). Thus, during mulching operation, no discharge port is open. As a result, the grass clippings are circulated within the cutting chamber 114 where they are repeatedly cut (mulched) by the cutting blade 116. The finely cut clippings may then fall back to the lawn surface 101.

To more effectively enclose the cutting chamber 114 during mulching mode, the mulch plug 129 may be inserted into the port 128 until a flange 123 (see FIG. 5) of the plug 129 contacts an outer surface of the deck 108 around the port 128. Cutouts 121 may then seat around protrusions, e.g., fastener heads 149, to assist in retaining the mulch plug 129 in place. A rear discharge port door 134 (further discussed below) may then be moved to its closed position as shown in FIG. 3 to assist in retaining the mulch plug 129 in place.

As shown in FIGS. 1, 3, and 4A-4C, a side discharge port door 132 may be provided to effect closing of the side discharge port 124 as desired for both bagging and mulching mode operation. FIGS. 4B and 4C are diagrammatic section views taken along line 4-4 of FIG. 2 (for clarity, these section views may exclude some features not necessary to an understanding of the invention). The door 132 illustrated herein is movable between an open position (see, e.g., FIGS. 3 and 4C) and a closed position (see, e.g., FIGS. 1 and 4B). Preferably, the door 132 opens by pivoting about a hinge line 189 (see FIG. 4B) and is normally biased to its closed position by a torsion spring 188 (see FIG. 4B) located along the hinge line 189.

The door 132 may include a latching device 180 as best shown in FIGS. 4A-4C. The latching device 180 allows secure, positive latching of the door 132 in the closed position. In one embodiment, the latching device 180 includes a latch member, e.g., a sliding member 182, which is slidable generally up and down in FIG. 4B. The sliding member 182 may engage a portion of the deck 108, e.g., a lower portion of the sidewall portion 109c as shown in FIG. 4B, when the door 132 is in the closed position. While most any shape is possible, the sliding member 182 may generally be L-shaped to provide a gripping portion 186.

The sliding member 182 may slide within a pocket 184 formed within the side discharge port door 132. The size of the pocket 184 may provide a slight interference fit with the sliding member 182 such that some frictional resistance to movement of the sliding member 182 occurs.

To latch the door 132, the sliding member 182 may be moved to an unlatched position (see FIG. 4C) by sliding the member 182 upwardly, e.g., in the direction 183 in FIG. 4B, a sufficient distance such that a lowermost end of the sliding member 182 clears the lower portion of the port 124 defined by the sidewall portion 109c (see FIG. 4B). The biasing force on the door 132 biases the door to its closed position wherein inside surfaces 190 of the door 132 abut a first, e.g., outer, side or surface 192 of the deck 108 along a perimeter of the port 124. The sliding member 182 may then be slid downwardly, e.g., in the direction 185 in FIG. 4B, until it abuts or is generally adjacent a second, e.g., inner, side or surface 194 of the deck 108. As a result, the latching device 180 of the present invention is operable to trap or sandwich a portion of the deck 108, e.g., a portion of the sidewall 109c, between the sliding member 182 and the door 132.

To configure the mower 100 for side discharge mode, the sliding member 182 may be moved in the direction 183 (see FIG. 4B) to its unlatch position and the door 132 raised as shown in FIGS. 3 and 4C. Once the door 132 is raised, the discharge deflector 126 may be installed as shown in FIGS. 4A and 4C. The discharge deflector 126 may include tabs 131 which engage hooks 135 on the hinge line of the door 132. Biasing of the door 132 to its closed position may assist in holding the discharge deflector 126 in place.

The deck assembly 102 may also include the rear discharge port door 134 associated with the rear discharge port 128 as shown in FIG. 5 to allow selective closing of the rear discharge port 128 for various operating modes of the mower 100. Like the side discharge port door 132, the rear discharge port door 134 is preferably biased to its closed position (which is illustrated in FIG. 3). This biasing may be accomplished by a torsion spring 141 (see FIG. 5) associated with a hinge rod 143 of the door 134. When the mower 100 is operating in bagging mode as shown in FIG. 1, the door 134 is held open by the engagement of the bag 130 with the mower 100. In one embodiment, the bag 130 includes two hooks 147 which engage the hinge rod 143 as shown in FIGS. 5 and 9. Gravity then maintains the bag 130 in place relative to the rear discharge port 128.

Mowers 100 of the present invention may be self-propelled in that one or both of either the two front wheels 104 or the two rear wheels 106 receive driving power from the engine 111. FIGS. 2 and 6 illustrate an exemplary rear wheel drive embodiment where a rear wheel drive transmission 136 provides drive power to a rear wheel axle or drive shaft 125r. The drive shaft 125r preferably drives a gear in operative engagement with each driven rear wheel 106.

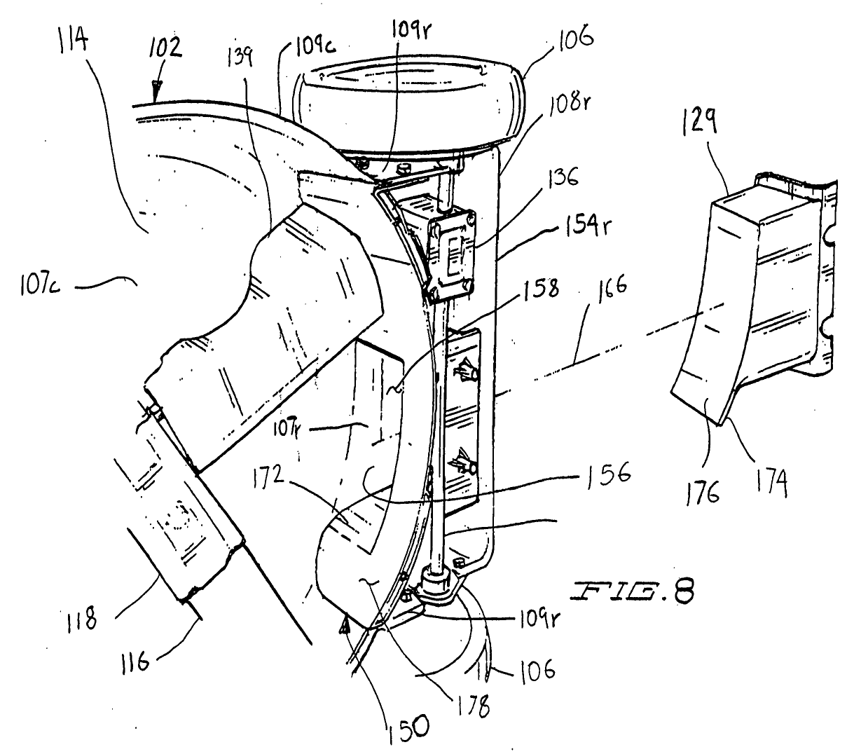

Power may be provided to the transmission 136 by a rear drive belt 138 which is coupled to a driving sheave 105 (see FIG. 6) of the blade coupler assembly 118. The driving sheave 105 and the belt 138 are preferably located below the deck 108 during operation. To at least partially isolate the belt 138 from grass clippings in the cutting chamber 114, a belt cover 139 may be provided as further described below. The belt cover 139 preferably has a contoured shape, as shown in FIGS. 2 and 8, which substantially conforms to a shape of the underside of the deck 108. As a result, there is less opportunity for grass clippings to interfere with the drive belt 138.

In alternate embodiments, the rear wheel drive transmission 136 may be replaced with a front wheel drive transmission 136′ located proximate the front wheels 104 as shown in hidden lines in FIGS. 2 and 6. When configured for front wheel drive, the transmission 136′ may be powered by a front drive belt 138′.

While shown as utilizing flexible endless belts 138, 138′, other driving members, e.g., chains, are also possible without departing from the scope of the invention.

In the illustrated embodiments of FIGS. 2 and 6, the belt 138 (for rear wheel drive configurations) is routed below the deck 108. That is, the belt 138 extends through the cutting chamber 114 to the rear wheel drive transmission 136. However, for front wheel drive configurations, the belt 138′ may extend, at least partially, above the deck 108 (in this configuration, a front belt cover (not shown) may extend along the top side of the deck to isolate the belt 138′). Routing the belt 138′ from the below deck driving sheave 105 to the above deck driven sheave of the transmission 136′ is achieved in part by the geometry of the front portion of the deck 108 which permits the formation of a window 140 through which the belt 138′ may pass. The transmission 136′ may then extend through an opening 127 in the deck 108 to power a front wheel drive axle or drive shaft 125f, which may itself be operatively coupled to one or both front wheels 104.

As a result, mower decks 108 of the present invention may be identical for either front or rear wheel drive applications. Accordingly, for rear wheel drive configurations, a blocking plate 137 (see FIG. 2) may be provided in order to cover the opening 127 used by the transmission 136′ for front wheel drive configurations.

The drive wheel configurations described herein are advantageous for several reasons. For example, the belt 138′ is substantially identical to the belt 138 such that a single belt may be used regardless of the drive wheel configuration. Likewise, except for their respective directions of rotation, the transmission 136′ is similar in most respects to the transmission 136. Moreover, the driving sheave 105, and thus the blade coupler assembly 118, may be used interchangeably between both front and rear wheel drive configurations.

In some embodiments, wheels 104 and 106 are of substantially the same size. However, where desirable, mowers 100 of the present invention may utilize a larger diameter rear wheel 106′ as shown in FIG. 3. While not limited to any particular configuration, larger rear wheels 106′ are preferably associated with front wheel drive configurations of the mower 100.

A height adjustment mechanism 142, which is partially illustrated in FIGS. 5 and 6, may be included to permit raising and lowering of the deck assembly 102 relative to the ground surface 101. The mechanism 142 may include one or more levers 144 which are operatively connected to all four wheels 104, 106. By selectively positioning the lever(s) 144, the deck assembly 102, and thus the height of cut, may be raised or lowered. As the configuration of the mechanism 142 is not central to the invention, portions of the mechanism 142 are removed from some views herein to improve clarity.

Attention is now directed to various embodiments of the deck assembly 102 with reference initially to FIG. 2. The deck 108 may include a central deck portion 108c, a front deck portion 108f, and a rear deck portion 108r. Preferably, the deck portions 108c, 108f, and 108r include central top wall portion 107c, front top wall portion 107f, and rear top wall portion 107r, respectively. Similarly, the deck portions 108c, 108f, and 108r may also include, respectively, central vertical sidewall portions 109c, front vertical sidewall portions 109f, and rear vertical sidewall portions 09r. The sidewall portions 109c, 109f, and 109r extend from their respective top wall portions 107c, 107f, and 107r downwardly toward the ground as shown in the Figures, see, e.g., FIGS. 1-3. The rear deck portion 108r may also include an end wall portion 154r while the front deck portion 108f may include an end wall portion 154f. Thus, the deck 108 generally forms an enclosure opening toward the ground.

Preferably, the deck 108 is integrally formed, e.g., the portions 108c, 108f, and 108r (including: top wall portions 107c, 107f, and 107r; sidewall portions 109c, 109f, and 109r; and end wall portions 154f and 154r) are stamped or cast as a single component. However, embodiments where the deck 108 is formed from multiple pieces which are subsequently assembled are also possible without departing from the scope of the invention.

The deck 108, and particularly the portion of the deck 108 that defines the cutting chamber 114, is tilted from front to back in FIG. 3 such that the cutting path of blade 116 is slightly lower in the front half of cutting chamber 114 than in the rear half of cutting chamber 114. This tilt of the mower deck 108, which may be approximately 1/2 inch from front to rear, aids in providing the proper inflow of air into the cutting chamber 114 about the bottom edge of the deck 108 and furthermore facilitates proper air discharge.

The lower side of the deck 108, e.g., the lower side of the top wall portion 107c of central deck portion 108c, may form an upper surface of the cutting chamber 114 as shown in FIG. 2. The vertical sidewall portions 109c of the central deck portion 108c of the deck 108 may form the sides of the cutting chamber 114. Preferably, these vertical sidewall portions 109c are arc-shaped as viewed in FIG. 2. Similarly, front and rear cutting chamber enclosure members 148 and 150 may form front and rear vertical wall portions 145, 146 of the cutting chamber 114. The wall portions 145, 146 are also preferably generally arc-shaped in the plan view of FIG. 2.

The vertical wall portions 145, 146 of the enclosure members 148 and 150 may extend downwardly to generally the same level as the sidewall portions 109c. More preferably, however, at least the vertical wall portion 145 of the front cutting chamber enclosure member 148 terminates above the lowermost edge of the sidewall portions 109c, e.g., the wall portion 145 does not extend downwardly toward the ground surface 101 as far as the sidewall portions 109c. When completely assembled, the sidewall portions 109c and the vertical wall portions 145, 146 define the perimeter of the generally cylindrically-shaped cutting chamber 114 as best illustrated in FIG. 2.

Sidewall portions 109c and vertical wall portions 145, 146 of front and rear cutting chamber enclosure members 148, 150 each have a substantially equivalent radius of curvature measured with respect to a rotational axis of the cutting blade 116. This radius of curvature is slightly larger than the radius of the outermost edge of the cutting blade 116.

In the embodiment of FIG. 2, the front cutting chamber enclosure member 148 is a separate component adapted to securely attach to the deck 108. For example, the enclosure member 148 may be formed as a separate, e.g., sheet metal, component which fastens by any conventional means (e.g., bolts, snap fits, or welds) to vertical sidewall portions 109f of the front deck portion 108f. Preferably, the enclosure member 148 includes a relief or extension chamber 152 similar to that described in U.S. Pat. No. 5,638,667 to Ellson et al. The extension chamber 152 may contribute to improved mulching of grass clippings when the mower 100 operates in mulching mode.

Like the front cutting chamber enclosure member 148, the rear cutting chamber enclosure member 150 is also preferably a separate component operable to securely attach to the deck 108, e.g., to the top wall 107r and/or sidewall 109r of the rear deck portion 108r. In one embodiment, the enclosure member 150 is formed as a separate plastic, e.g., polyethylene, component that is fastened by any conventional means (e.g., bolt or snap fit) to one or both of the top wall 107r and the sidewalls 109r.

The rear cutting chamber enclosure member 150 may include a cutout (not shown) to allow passage of the belt 138 (see FIG. 2) to the transmission 136 for rear wheel drive configurations. The cutout is preferably surrounded by the belt cover 139 as shown in FIG. 8 to prevent or at least reduce grass clippings from passing through to the side of the rear enclosure member 150 opposite the cutting chamber 114. As those skilled in the art will realize, the cutout would not be required for front wheel drive configurations. Thus, for front wheel drive configurations, the mower 100 could utilize a rear enclosure member without the cutout or, alternatively, could utilize a plug or insert to seal the cutout.

With reference to FIGS. 5, 7, 8, and 9, the rear deck portion 108r includes, in addition to its vertically disposed sidewall portions 109r, the generally vertical end wall portion 154r through which is formed the rear discharge port 128. Extending between the rear discharge port 128 and the cutting chamber 114 is a substantially enclosed passageway or duct 156. During operation in bagging mode, grass clippings are directed from the cutting chamber 114 to the bag 130 via the duct 156.

At least a portion of the duct 156 is preferably formed in the rear enclosure member 150 as illustrated in FIGS. 5, 7, 8 and 9. More specifically, the duct 156 may be formed as a U-shaped channel in the enclosure member 150 such that, when installed, an underside of the top wall portion 107r of the rear deck portion 108r forms an uppermost surface 158 of the duct 156 while the U-shaped channel in the enclosure member 150 defines a lowermost surface 160 and opposing side surfaces 162, 164.

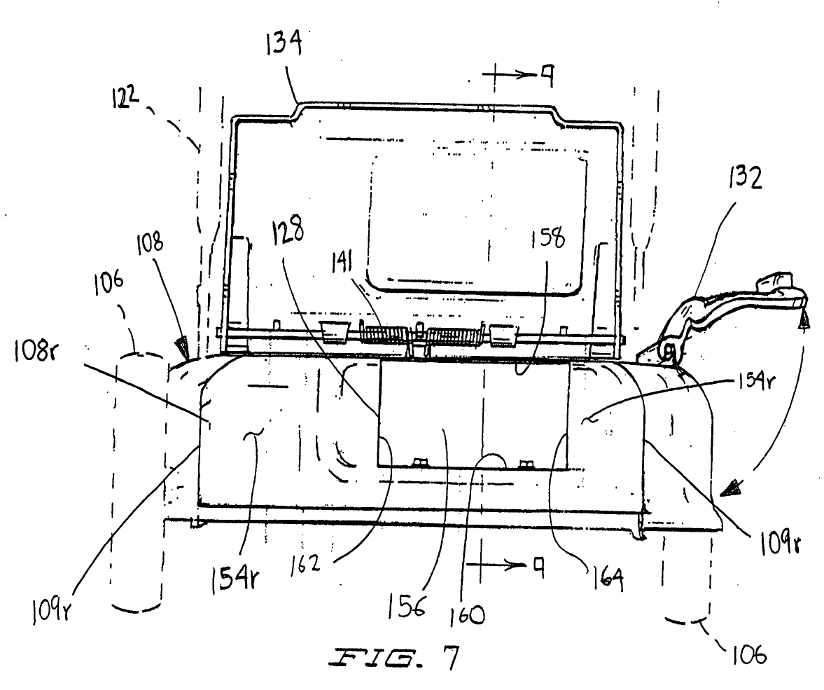

Preferably, the duct 156 is of substantially rectangular cross section and has a generally symmetric duct axis 166 lying within a horizontal plane as shown in FIGS. 5, 8, and 9. Moreover, the duct axis 166 is preferably substantially parallel to a longitudinal axis 170 of the mower 100 (see FIG. 2). As a result, the uppermost surface 158 and the lowermost surface 160 of the duct 156 form substantially horizontal, parallel planes as shown in FIGS. 7 and 9, while the opposing side surfaces 162, 164 form substantially vertical, parallel planes. Preferably, the duct has a transverse width greater than its vertical height.

Mowers 100 in accordance with the present invention are able to provide this relatively horizontal duct 156 because, for example, the transmission 136 and drive belt 138 may be positioned at a relatively low elevation, e.g., the cutting belt 138 routes through the cutting chamber 114 along the underside of the deck 108. As a result, the bag 130 may be mounted low such that there is little or no need to substantially elevate the grass clippings as they are discharged from the cutting chamber 114.

The duct 156, as described and illustrated herein, is advantageous for numerous reasons. For instance, it provides close coupling of the bag 130 to the cutting chamber 114, allowing a generally horizontal and straight discharge path as opposed to the upwardly angled discharge path common with scrolled decks. Moreover, the horizontal duct 156 provides less complicated deck construction as no scroll or elevated discharge conduit is required. Rather, a relatively flat deck can be used where the discharge path is formed by a simple rear enclosure member. The rectangular cross section of the duct 156 also permits generally configuring the mulch plug 129 with a simplified rectangular cross section as shown in FIGS. 5 and 8.

To improve the flow of grass clippings from the cutting chamber 114 to the duct 156 during bagging, a corner 172 of the duct 156 may have a generous radius as shown in FIG. 8. To mask this radius during mulching operation, the duct plug 129 may include an ear 174 such that, when the mulch plug 129 is installed, a face 176 of the mulch plug 129 substantially coincides with a face 178 of the rear enclosure member 150, providing a generally uninterrupted and continuous arc-shaped surface along the rear enclosure member 150.

Other advantages of the present invention include the ability to use the same mower deck, as well as the same belt and driving sheave/blade coupler assembly, in both front and rear wheel drive configurations. Similarly, the transmission used to drive the rear wheels utilizes most of the same components as the transmission used to drive the front wheels (reversed rotation necessitates some minor differences). As a result, both front and rear wheel drive mowers in accordance with the present invention share many common parts, permitting potentially significant manufacturing efficiencies.

The complete disclosure of the patents, patent documents, and publications cited in the Background of the Invention, the Detailed Description of Exemplary Embodiments, and elsewhere herein are incorporated by reference in their entirety as if each were individually incorporated.

Exemplary embodiments of the present invention are described above. Those skilled in the art will recognize that many embodiments are possible within the scope of the invention. Other variations, modifications, and combinations of the various parts and assemblies can certainly be made and still fall within the scope of the invention. Thus, the invention is limited only by the following claims, and equivalents thereto.

What is claimed is:

1. A deck assembly for a self-propelled, walk-behind rotary lawn mower, the deck assembly comprising a deck defining a cutting chamber for housing a cutting member, the deck having a top wall portion spanning above the cutting chamber between a front portion of the deck and a rear portion of the deck, the deck operable to receive either a rear wheel drive transmission proximate the rear portion of the deck, or a front wheel drive transmission proximate the front portion of the deck.

2. The deck assembly of claim 1, wherein the rear wheel drive transmission is operable to couple to a prime mover attached to the deck via a rear drive belt located below the top wall portion of the deck, and the front wheel drive transmission is operable to couple to the prime mover via a front drive belt located at least partially above the top wall portion of the deck.

3. The deck assembly of claim 2, wherein the front wheel drive transmission is locatable substantially below the top wall portion of the deck, and further wherein the front portion of the deck includes an opening operable to permit coupling of the front drive belt to the front wheel drive transmission.

4. The deck assembly of claim 3, further comprising a blocking plate operable to substantially cover the opening when the mower is configured for use with the rear wheel drive transmission.

5. The deck assembly of claim 2, wherein the front drive belt is substantially identical to the rear drive belt.

6. A deck assembly for a walk-behind rotary lawn mower, the deck assembly comprising:
a deck defining a cutting chamber operable to house a cutting member, wherein the cutting chamber is bound at least in part by a rear enclosure member;
a rear discharge port located, when the mower is in an operating configuration, on a rear portion of the deck; and
a duct of substantially rectangular cross section extending through the rear enclosure member between the cutting chamber and the rear discharge port, the duct having a first, uppermost surface and a second, lowermost surface, wherein the first, uppermost surface and the second, lowermost surface both form substantially horizontal planes.

7. The deck assembly of claim 6, further comprising a mulch plug operable to engage and selectively plug the duct.

8. The deck assembly of claim 6, wherein the first, uppermost surface is formed at least in part by an underside of the deck.

9. The deck assembly of claim 6, wherein the duct is formed at least in part by the rear enclosure member.

10. The deck assembly of claim 6, wherein the rear enclosure member defines at least a portion of the second, lowermost surface.

11. The deck assembly of claim 6, wherein the rear enclosure member is secured to the deck with one or more fasteners.

12. The deck assembly of claim 6, wherein a duct axis of the duct is substantially parallel to a longitudinal axis of the mower.

13. The deck assembly of claim 12, wherein the duct axis of the duct is laterally offset from the longitudinal axis of the mower.

14. A deck assembly for a walk-behind rotary lawn mower, the deck assembly comprising:
a deck defining a cutting chamber operable to house a cutting member, wherein the cutting chamber is bound at least in part by a rear enclosure member;
a rectangular rear discharge port located, when the mower is in an operating configuration, on a rear portion of the deck; and
a duct of substantially rectangular cross section extending through the rear enclosure member between the cutting chamber and the rectangular rear discharge port, the duct defining a duct axis that is substantially parallel to a longitudinal axis of the mower.

15. The deck assembly of claim 14, wherein the rectangular rear discharge port has a transverse width and a vertical height, wherein the transverse width is greater than the vertical height.

16. The deck assembly of claim 14, wherein at least a portion of the duct is formed by an underside of the deck.

17. The deck assembly of claim 14, wherein at least a portion of the duct is formed by the rear enclosure member.

18. The deck assembly of claim 14, further comprising a transmission proximate the rear discharge port and operable to power two rear wheels, wherein the transmission is drivingly coupled to a prime mover via an endless belt.

19. The deck assembly of claim 18, wherein the endless belt extends through the cutting chamber along an underside of the deck.

20. The deck assembly of claim 18, wherein the endless belt extends through a portion of the rear enclosure member.

21. The deck assembly of claim 20, wherein the endless belt is at least partially enclosed between an underside of the deck and a belt cover secured to the underside of the deck.

22. The deck assembly of claim 21, wherein the belt cover has a shape that substantially conforms to a shape of the underside of the deck.

23. The deck assembly of claim 21, wherein the belt cover abuts the rear enclosure member.

24. The deck assembly of claim 14, further comprising a side discharge port located, when the lawn mower is in the operating configuration, generally along a lateral side portion of the mower, the side discharge port having a door associated therewith, the door operable to selectively cover the side discharge port.

25. A walk-behind rotary lawn mower, comprising:
a deck assembly comprising:
a deck defining a cutting chamber operable to house a cutting member, wherein the cutting chamber is bound at least in part by a rear enclosure member;
a side discharge port located, when the mower is in an operating configuration, generally along a lateral side portion of the deck, the side discharge port having a door associated therewith, the door operable to selectively cover the side discharge port;
a substantially rectangular rear discharge port located, when the mower is in the operating configuration, on a rear portion of the deck; and
a duct of generally rectangular cross section extending between the cutting chamber and the rear discharge port, the duct defined in part by a lower surface and an upper surface, wherein both the lower surface and the upper surface form substantially horizontal planes;
a plurality of wheels operable to support at least the deck assembly in rolling engagement with a ground surface;
a prime mover coupled to the deck assembly; and
a cutting blade located within the cutting chamber, the cutting blade rotatable under control of the prime mover.

26. The lawn mower of claim 25, wherein the duct is formed at least in part by the rear enclosure member.

27. The lawn mower of claim 25, wherein the rear enclosure member defines opposing sides of the duct, the opposing sides forming substantially vertical planes.

28. The lawn mower of claim 25, further comprising a collection apparatus operable to fluidly couple to the rear discharge port.

29. The lawn mower of claim 25, wherein one or more of the plurality of wheels is operatively driven by the prime mover.

30. The lawn mower of claim 25, further comprising a mulch plug operable to engage and effectively seal the rear discharge port.

31. The lawn mower of claim 25, wherein the door further comprises a latching device operable to substantially immobilize the door when the door covers the side discharge port.

32. A self-propelled, walk-behind rotary lawn mower, comprising:
a deck assembly comprising a deck defining a cutting chamber for housing a cutting member, the deck having a top wall portion spanning above the cutting chamber between a front portion of the deck and a rear portion of the deck, the deck operable to receive either a rear wheel drive transmission proximate the rear portion of the deck, or a front wheel drive transmission proximate the front portion of the deck;
a plurality of wheels operable to support at least the deck assembly in rolling engagement with a ground surface;
a prime mover coupled to the deck assembly; and
a cutting blade located within the cutting chamber, the cutting blade rotatable under control of the prime mover.

33. The lawn mower of claim 32, wherein the rear wheel drive transmission is operable to couple to the prime mover via a rear drive belt located below the top wall portion of the deck, and the front wheel drive transmission is operable to couple to the prime mover via a front drive belt located at least partially above the top wall portion of the deck.
